(19) United States
(12) Patent Application Publication
(10) Pub. No.: US 2018/0364153 A1
(43) Pub. Date: Dec. 20, 2018

(54) Absorptive Spectrometer with Integrated Photonic and Phononic Structures

(71) Applicant: William N Carr, Raleigh, NC (US)

(72) Inventor: William N Carr, Raleigh, NC (US)

(21) Appl. No.: 15/624,625

(22) Filed: Jun. 15, 2017

(51) Int. Cl. G01N 21/25; G01N 21/35; G02B 6/122; G01J 5/12

(52) U.S. Cl. CPC G01N 21/255; G01N 21/35; G01N 2201/0231; G01J 5/12; G01N 2201/0873; G02B 6/1225

(57) ABSTRACT

An infrared spectrometer chip including a suspended micro-platform, the suspended micro-platform being configured as a thermal detector with integrated photonic and phononic structure. The chip in embodiments includes temperature controlled elements including a photonic source, filter, sensor and detector. Thermoelectric devices are disposed on the micro-platform.

### FIELD OF THE INVENTION

This invention relates generally to a nanostructured spectrophotometer with an integrated photonic crystal waveguide and phononic structures.

### BACKGROUND OF THE INVENTION

Absorptive spectrophotometry is the quantitative measurement of the absorption of an analyte as a function of wavelength. An absorptive spectrophotometer is commonly used to measure the spectral absorption of a photonic beam modulated by exposure to, transmission through or backscatter from gases, vapors and particulates among other materials.

Defect-engineered photonic crystals with submicron dimensions have demonstrated a high sensitivity to trace volumes of analytes for performing a number of sensing applications. Specifically, optical absorbance power transmitted through a 2-D and 3-D photonic crystal waveguide (PCW) is modulated by the presence of exposed or absorbed analytes. The transmitted infrared power or phase delay of the signal propagation through adapted PCW structures provides a detected signal signature unique to the exposed, absorbing, or reflecting substances.

It is known that for improved detection with an absorptive spectrophotometer, it is desirable to enhance the optical interaction between the propagating photonic wave and an analyte of interest. In embodiments this can be done by operating a PCW in a slow wave mode and exposing its high field area to an analyte of interest. The PCW may have a core guide structure characterized as slab, holey or slotted.

Prior photonic art related to using PCW structures includes coupling light from a laser, optical fiber, focused beam or other source into structures having power distribution via conventional photonic waveguide (PW) to photonic crystal waveguide (PCW) couplers, and unique PCW filtering, sensing and termination structures.

Prior related phononic art discloses on-chip thermal sensors comprised of thermally-isolated micro-platforms tethered by beams comprised of nanoscale and molecular structures to reduce thermal conductivity. Prior art discloses thermoelectric Seebeck active devices and thermoelectric passive resistive heaters, bolometers, thermistors and Peltier cooling devices.

Prior art for on-chip photonic sources PS is disclosed in U.S. Pat. No. 7,065,272 and is depicted in FIG. 1A and FIG. 1B. FIG. 1A depicts a prior art photonic source PS with an exiting signal provided through a photonic crystal waveguide PCW 130. A 1-D diffraction grating 120 illuminated from a photonic source external to the grating launches a photonic signal which propagates successively through a tapered slab waveguide 110, a conventional slab waveguide and on into a PCW 130.

FIG. 1B depicts a prior art photonic source PS with an exiting signal provided through a slab waveguide 160. A 2-D diffraction grating 150 illuminated from a photonic source external to the grating launches a photonic signal which propagates successively through a tapered slab waveguide 140, and into a conventional photonic waveguide PW.

Prior art disclosed in U.S. Pat. No. 6,643,439 is depicted in FIG. 2A. A photonic crystal waveguide PCW is disclosed comprised of a holey core guide 220, a first cladding 210 and a second cladding 260. The cladding is structured as holes in the same dielectric film as the holey core guide. The photonic crystal cladding structures adjacent to the core guide create a lower effective refractive index compared to the refractive index of the core structure thereby confining the propagating signal to the core. Prior art FIG. 2A depicts a photonic crystal waveguide PCW with a slab core.

A prior art ridge photonic crystal waveguide 200A is coupled to entrance and exit conventional slab photonic waveguides PW as disclosed in U.S. Pat. No. 7,072,547. An impedance matching coupling between the slab photonic waveguide PW and the photonic crystal waveguide 200A is implemented with resonators of varying spatial period. The coupling structure 310 is characterized by limited wavelength bandpass. In this coupler a series of resonators of uniform spatial period are disposed in a manner wherein cladding holes are spaced closer at an angle the cladding bulk of the photonic crystal waveguide. An adiabatic introduction of the photonic crystal reduces reflections at the edges and Fabry-Perot resonance in the overall structure. The coupler applies to PCWs with 2-D cladding comprised of holes and with square, triangular and hexagonal crystal lattice geometries.

In prior art depicted in FIGS. 4A,4B and 4C a photonic crystal waveguide (PCW) with resonant cavities is exposed to an analyte which modulates attenuation of the photonic wave propagating through the PCW. These structures are types of a photonic crystal waveguide sensor and are usually operated in the slow-mode wavelength region. Attenuation of a propagating photonic wave through the PCW operated in the slow-mode region is highly sensitive to very small changes in the refractive index of material on or immediately adjacent to a resonant cavity or other photonic absorptive structure.

Prior art FIGS. 4A, 4B and 4C depict a photonic crystal waveguide PCW with resonant cavities or defect areas which can increase the attenuation of a propagating photonic wave in the core due to minute changes in a nearby media of differing refractive index. FIG. 4A depicts a prior art photonic crystal waveguide PCW 400A with two high-Q resonant cavities 410 and 420 disposed in-line with a slab core 400, A first cladding structure 440 and a second cladding structure 450 confine the propagating signal to the core guide 400. The core is dimensioned to provide a maximum dispersion of refractive index for the propagating signal. This mode of operation is characterized as a “slow wave” wherein the wave velocity of signal is greatly reduced from what it would be in a conventional photonic waveguide PW. The attenuation of the slow wave is sensitive to minute variations in effective refractive index provided by the two in-line resonant cavities 410 and 420.

FIG. 4B depicts another prior art photonic crystal waveguide having a high-Q resonant cavity 470 disposed within the evanescent field but outside the slab core 460.

The photonic crystal waveguide PCW is comprised of a first cladding structure 480 and a second cladding structure 490.

FIG. 4C depicts another prior art photonic crystal waveguide having a high-Q resonant cavity 435 disposed in line with a slab waveguide and within a Mach-Zehnder interferometer. The propagating phase delay of the photonic signal input at location 405 through a slab-type core guides is divided into signals continuing through cores 425 and 430. The PCW is comprised of three cladding structures 445, 455, and 465. The phase delay through core 430 is sensitive to minute changes in the refractive index associated with resonant cavity 435. An analyte of interest exposed to the resonant cavity 435 modulates the phase delay in core arm 430. When the two signals are combined into the exit guide 415. The combined temporal vector addition of the two signals provides an increased modulation of exiting signal amplitude when the resonator 435 is exposed to an analyte of interest. The use of a Mach-Zehnder interferometer within a photonic crystal waveguide PCW is disclosed in U.S. Pat. No. 6,917,431. All three sensor structures comprised of photonic crystal waveguide PCW structures exhibit an enhanced sensitivity to small changes in the refractive index of an analyte within the electromagnetic field of the high-Q resonant cavities.

FIG. 5 depicts a prior art absorbing boundary used to terminate a photonic crystal waveguide PCW. In this structure spurious reflections from a photonic signal wave entering the core 510 is suppressed by a perfectly matched Bragg reflectance structure 520. The wave propagating from 510 through the core slab is terminated with no reflection when the dimensions Δ₁ and Δ₂−Δ₁ are optimally adjusted. Photonic structures 530 and 540 comprise cladding for the absorbing signal termination structure.

FIG. 6 depicts prior art disclosed in U.S. Pat. No. 9,164,026 with a plurality of photonic crystal waveguide sensors disposed on a chip. The chip is comprised of a input and output grating couplers for connecting an external photonic source and an external photonic detector, respectively.

Related prior art phononic structures with thermal sensors disposed on micro-platforms are disclosed in U.S. Pat. Nos. 9,006,857 and 9,236,552 and US Patent Application 2016/0240762. These patents disclose structures depicted in FIG. 7 and FIG. 8. Nano and molecular-structured phononic scattering structures in tetherbeams supporting a micro-platform which provide a reduction in thermal conductivity thereby thermally isolating the micro-platform are disclosed. These phononic structures provide a desirable decrease in the ratio of thermal conductivity to electrical conductivity of a tetherbeam. In this prior art, micro-platforms are disclosed with on-platform temperature sensing devices such as a thermocouple, bolometer, thermistor and a semiconductor bandgap diode. Thermoelectric devices disposed on the thermally-isolated micro-platform provide a response to very small changes in temperature in addition to providing a heating and cooling function.

FIG. 7 depicts a plan view of a prior art phononic tetherbeam 710 providing support for a micro-platform. The tetherbeam is depicted as comprised of scattering holes 700. The diameter and separations of the example holes 700 are of dimension D1 and D2 optimized to minimize thermal conductivity of the tetherbeam 710.

FIG. 8 depicts a prior art micro-platform 810 supported by phononic tetherbeams 812 and comprised of a plurality of sensor types. The surrounding support platform 804 defines the boundary 806 surrounding a cavity 808. The cavity underlies the micro-platform 810 and tetherbeams 812. In embodiments sensors comprise Seebeck thermoelectric devices 836 and Peltier thermoelectric devices 820 for sensing and cooling, respectively. A resistive heater 834 disposed on the micro-platform 810 is disclosed. A thermistor 832 which provides a temperature sensor for closed loop temperature control of the Peltier cooling and resistive heating devices. The micro-platform is an isothermal structure. The micro-platform and tetherbeams are formed using well known micromachining technology including deep submicron lithography.

### SUMMARY OF THE INVENTION

The present invention improves upon prior art for infrared spectrophotometers by integrating a photonic crystal waveguide (PCW) with performance enhancing thermal structures using on-chip integration technologies. Phononic structures including thermoelectric devices of the present spectrophotometer invention include a means of extending the wavelength sensing range into the far infrared using an integrated thermoelectric detector comprised of a thermal energy absorber and a thermal sensor. A PCW adapted for slow wave operation and resonant sensor cavities provides a highly sensitive spectrophotometer function sensitive to a variety of analytes. Tetherbeams comprised of integrated photonic and phononic (IP&P) structures are comprised of photonic waveguide (PW) and photonic crystal waveguide (PCW) structures together with phononic thermal conductivity-reducing structures. These IP&P structures are disposed on chip to provide a photonic link thereto and thermally isolate a multi-function micro-platform.

Additional novel features in embodiments include providing for a spectrophotometer having controlled on-chip closed loop temperature control and structured PCWs disposed on a thermally-isolated micro-platform. Temperature control of a PCW structure permits additional applications wherein an analyte is maintained within a controlled temperature range. This permits outgassing of an analyte residue which may accumulate over time in and on the phononic crystal waveguide PCW. Temperature control on the micro-platform also permits adapting a chip to provide for dynamic beam switching, bandwidth control, wavelength tuning and support for synchronous detection circuitry. Elements of the spectrophotometer are thermally isolated with phononic scattering tetherbeams comprised of IP&P structures

The primary objective of the invention is to provide a highly sensitive on-chip absorption spectrometer comprising a photonic source, PCW waveguide filters, sensors and a detector disposed in and on a monolithic chip and providing a sensitivity at selected wavelengths within the range of near infrared to millimeter wavelengths and further configured for spectroscopic identification based on unique spectral absorption signatures of gases, vapors, particulates liquids and biomolecular samples. Portions of the waveguide and detector structures are integrated to provide a reduced footprint.

A second objective of the invention is to provide a spectrophotometer where portions of the waveguide and detector structures are integrated to provide a reduced footprint and reduced power requirement. In embodiments the spectrophotometer is structured as an apparatus attached to and powered by a mobile phone.

A third objective of the invention is to provide an on-chip spectrophotometer comprised of an integrated PCW and a thermal detector with a multiplicity of sampling cells each sensitive to one or more specific wavelengths, dilution levels and molecular densities providing for a more complete spectral analysis of the analyte of interest.

A fourth objective of the invention is to provide on on-chip spectrophotometer with a temperature-controlled PCW sensing element disposed on a thermally-isolated platform. The PCW is disposed on a micro-platform heated by a resistive heater or cooled by Peltier thermoelectric devices. This permits a more precise spectral analysis of an analyte at multiple temperatures. The thermal micro-platform permits immediate outgassing of analyte residue from the sensor and detector elements thereby providing a “reset” function for spectrophotometer calibrations.

A fifth objective of the invention is to provide a sampling cell with a PCW disposed on a micro-platform providing a spectral analysis at a monitored or controlled temperature for an analyte undergoing a chemical or biological reaction process.

A sixth objective of the invention is to provide a micro-platform comprised of both infrared thermoelectric sensing devices and bandgap diode sensing devices providing sensitivity over a wavelength spectrum extending to wavelengths shorter than infrared.

A seventh objective of the invention is to provide a metamaterial filtered blackbody photonic source coupled into a PCW.

In embodiments the spectrophotometer is comprised of a photonic source (PS), a photon crystal waveguide filter (PCWF) a photonic crystal waveguide sensor (PCWS) and a photonic crystal waveguide detector (PCWD) disposed on a chip generally with a semiconductor substrate. The spectrometer is further comprised of one or more integrated photonic and phononic (IP&P) structures proximal to a micro platform. Standard photonic waveguide (PW) and photonic crystal crystal waveguide (PCW) sections provides the photonic signal path from the source PS through the sensor PCWS and to the detector PCWD. In some embodiments an intermediate photonic crystal waveguide filter PWCF is disposed intermediate between the source PS and the sensor PCWS structures on chip.

In embodiments the spectrophotometer is adapted to provide a means of detecting and monitoring minute amounts of an analyte including gases, vapors, liquids, and particulates exposed to the slow-wave structure within a sensor PCWS. In other embodiments the spectrophotometer is adapted to provide a means of detecting and monitoring a photonic beam reflected from or transmitted through an external environment into the source PS. In embodiments the spectrophotometer provides a photonic wattmeter monitoring the optical power dissipated into the detector PCWD.

In embodiments the spectrophotometer is adapted to provide spectral analysis within a selected wavelength range at a monitored or controlled temperature for an analyte undergoing a chemical or biological reaction process.

In embodiments the photonic source PS or filter PCWF is adapted as a photothermal modulator providing a modulation of the signal transmitted to a detector PCWD. In some embodiments a synchronous detection is implemented by synchronizing with external circuit switching to provide a photospectrometer with improved signal to noise ratio.

The maximum useful sensitivity of the spectrophotometer is limited by the photonic signal level available from the source PS, the effective Q of the sensor PCWS cells, on-chip spurious signal attenuation, the signal to noise level available from the detector PCWD, and external signal conditioning circuitry.

Analytes exposed to the sensor PCWS are characterized by unique infrared absorptive spectra, often resulting from specific molecular vibration resonances of molecules. These absorptive spectra are temperature dependent. In some instances, the sensitivity to an analyte is increased at elevated temperatures. This variation in absorption with temperature provides an additional opportunity for more selective monitoring and identification of an analyte when the temperature of the analyte and sensor PCWS are controlled on chip.

In embodiments the sensor PCWS is comprised of a resistive heater which elevates the sensing temperature. In other embodiments the sensor PCWS is cooled by a Peltier thermoelectric device integral to the micro-platform of the PCWS. An analysis of detector signal obtained over a temperature range provides a desirable increase in overall selectivity and sensitivity for the spectrophotometer In many applications. This adaptation is especially useful when the response to a particular chemical species of interest is highly temperature dependent and there are additional species present but with differing temperature response coefficients within the particular wavelength band of sensitivity.

In embodiments the spectrophotometer is structured to provide a response with and without coupling to an analyte. This provides for a differential analysis of the analyte. In one embodiment a differential analysis is performed based on a comparison of detector PCWD signals obtained from a plurality of a sensors PCWS with and without an analyte being sensed. A differential analysis of an analyte may also be obtained by using the filter PCWF as a photonic switch to enable separate sensing PCWS guided paths into a single detector PCWD. For example, in other embodiments detector signals may be acquired at different times from a single multi-input sensor PCWS or by beam switching between two separate sensor PCWS structures.

Sensing an analyte with detection provided by a detector PCWD may also include modulation of a photonic signal external to the chip. In some embodiments the photon source is comprised of transmitted or backscattered radiation focused and collected into a grating coupler. This externally-modulated photonic beam is coupled into an on-chip filter PCWF and detector PCWD. In this embodiment the spectrophotometer provides an analysis of gases,vapors and particulates of interest disposed external to the chip.

Analytes that can be identified using embodiments of the invention include, without limitation:
pollutant gases such as greenhouse gases carbon dioxide, carbon monoxide, methane, nitrous oxide, chlorofluorocarbons, and ozone;.
volatile organic compounds such as benzene, toluene, xylene, and ethylbenzene;
highly toxic gases such as ammonia, arsine, chlorine, boron tribromide, and sarin;
explosives such as trinitrotoluene (TNT) and RDX.
By-product gases from combustion-engine exhausts, stack exhausts in coal plants, chemical plants and oil refineries.

### BRIEF DESCRIPTION OF THE DRAWINGS

FIG. 1A depicts plan view of a prior art photonic diffraction grating configured as a coupler into a photonic crystal waveguide providing one type of a photonic source PS when supplied by an emitter external to the chip.

FIG. 1B depicts a plan view of a prior art photonic diffraction grating configured as a coupler into a photonic slab waveguide providing a photonic source PS when supplied by an emitter external to the chip.

FIG. 2A depicts a plan view of a prior art photonic crystal waveguide with a holey waveguide core providing a bandwidth filter or photonic interconnect.

FIG. 2B depicts a plan view of a prior art photonic crystal waveguide with a slab waveguide core providing a bandwidth filter or photonic interconnect.

FIG. 3 depicts a plan view of a prior art photonic crystal waveguide with a holey core interfaced to a slab waveguides at input and output.

FIG. 4A depicts a plan view of a prior art photonic crystal waveguide sensor structured with two resonant high-Q sensor cavities within the slab core.

FIG. 4B depicts plan view of a prior art photonic crystal waveguide sensor structured with a resonant high-Q sensor cavity embedded into the cladding adjacent to the slab core.

FIG. 4C depicts plan view of a prior art photonic crystal waveguide sensor structured with a Mach-Zehnder interferometer having an internal high-Q resonant sensor cavity.

FIG. 5 depicts a plan view of a prior art photonic crystal waveguide with a non-reflecting photonic crystal termination.

FIG. 6 depicts a plan view of a prior art photonic chip structured with a photonic crystal waveguide sensor and with photonic input and output couplers.

FIG. 7 depicts plan view of a prior art tetherbeam with phononic scattering structures.

FIG. 8 depicts a plan view of a prior art thermally-isolated micro-platform supported by tetherbeams with phononic scattering structures

FIG. 9A depicts a plan view of a first photonic crystal waveguide filter PCWF embodiment comprised of integrated IP&P structures in accordance with embodiments of the invention

FIG. 9B depicts plan view of a second photonic crystal filter PCWF embodiment in accordance with embodiments of the invention.

FIG. 10A, 10B and 10C depict respective first, second and third plan views of photonic crystal waveguide sensor PCWS embodiments in accordance with embodiments of the invention

FIG. 11 depicts a plan view of a photonic crystal waveguide detector PCWD comprised of a thermally-isolated and thermally-heated micro-platform further comprising a thermoelectric Peltier array and a photonic crystal waveguide terminated in a zero-reflecting termination structure and where one PCW supporting tetherbeam is comprised of integrated photonic and phononic IP&P structures in accordance with embodiments of the invention.

FIG. 12A is a schematic depicting a chip comprising a photonic source PS, a photonic crystal waveguide sensor PCWS and a photonic crystal detector PCWD in accordance with embodiments of the invention.

FIG. 12B is a plan view depicting the chip of FIG. 12A comprising a 1D grating photonic source, a sensor micro-platform with a high-Q resonant cavity embedded in the cladding photonic crystal, and a photonic crystal waveguide detector PCWD with three phononic IP&P structures n accordance with embodiments of the invention.

FIG. 13A is a schematic depicting a chip comprising a photonic source PS, a photonic crystal waveguide filter PCWF, a photonic crystal waveguide sensor PCWS and a photonic crystal detector PCWD further comprising three integrated IP&P structures in accordance with embodiments of this invention..

FIG. 13B is a plan view depicting the chip of FIG. 13A comprising a 1D grating photonic source, a temperature-controlled photonic crystal waveguide filter PCWF, a sensor micro-platform PCWS, and a photonic crystal waveguide detector PCWD, further comprising five integrated IP&P structures in accordance with embodiments of the invention.

FIG. 14A is a schematic depicting a chip comprised of a photonic source PS having a single micro-platform for the sensor PCWS and detector PCWD in accordance with embodiments of the invention.

FIG.14B is a schematic depicting a chip comprised of a photonic source PS, a photonic crystal waveguide filter PCWF and having a single micro-platform for both the sensor PCWS and detector PCWD in accordance with embodiments of the invention.

FIG. 15 is a plan view depicting a chip structured as an embodiment depicted in

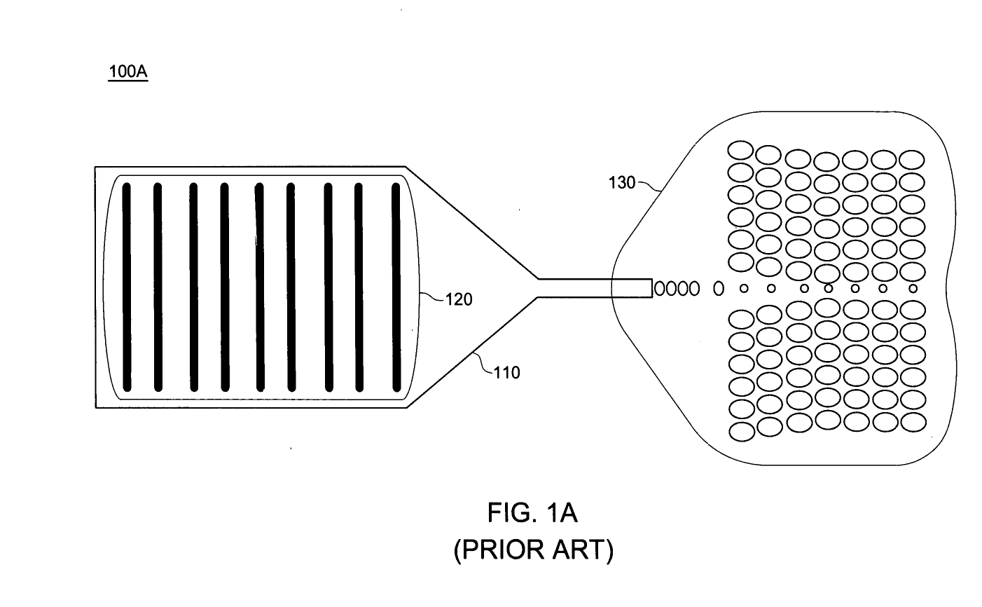

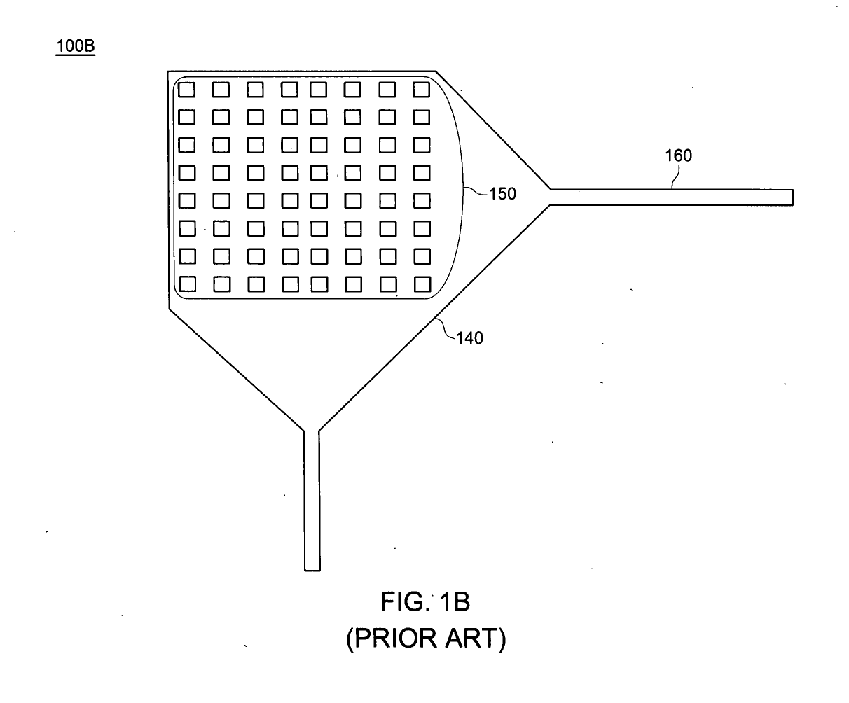

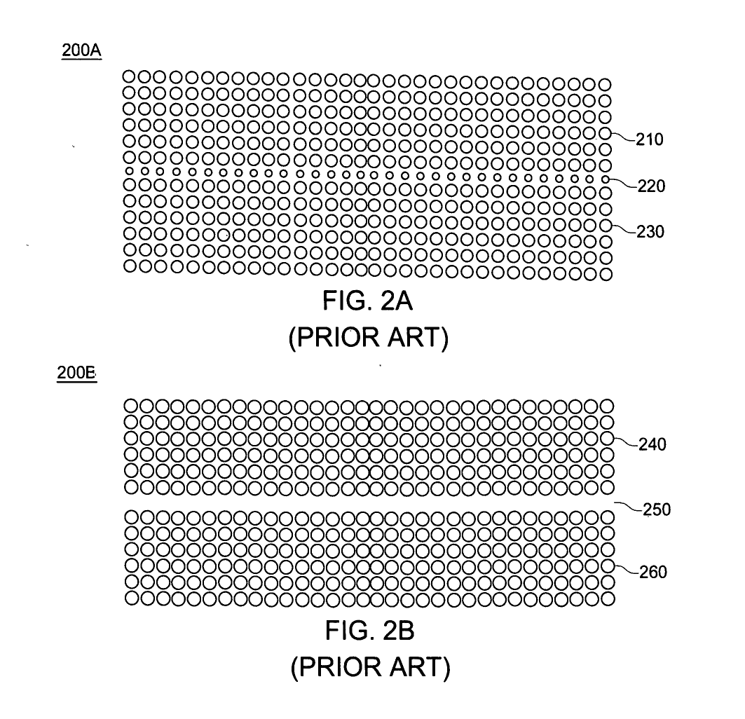

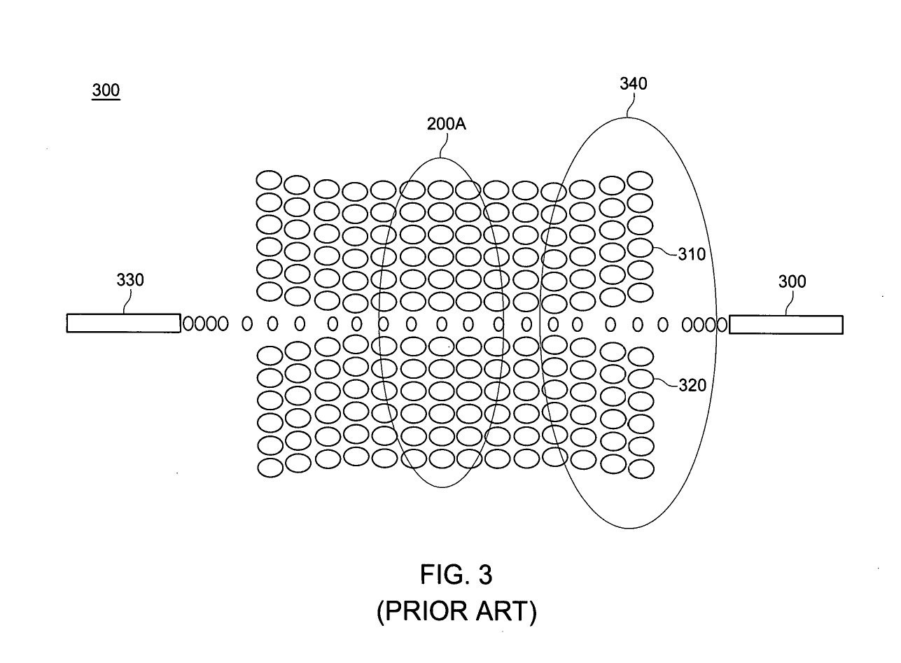

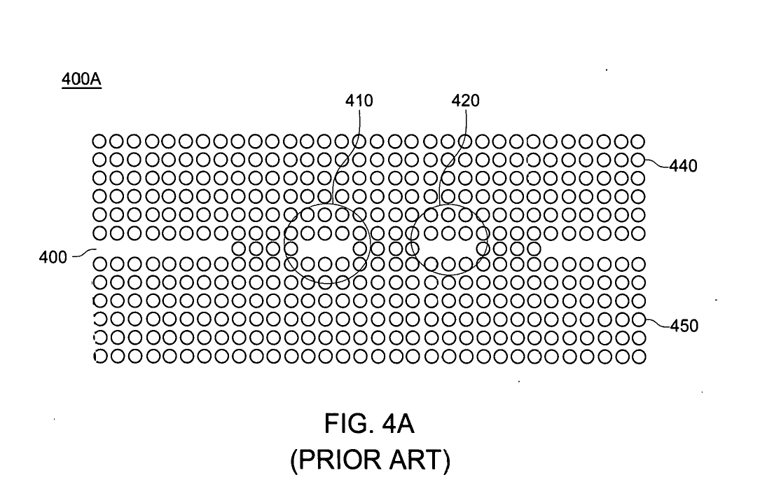

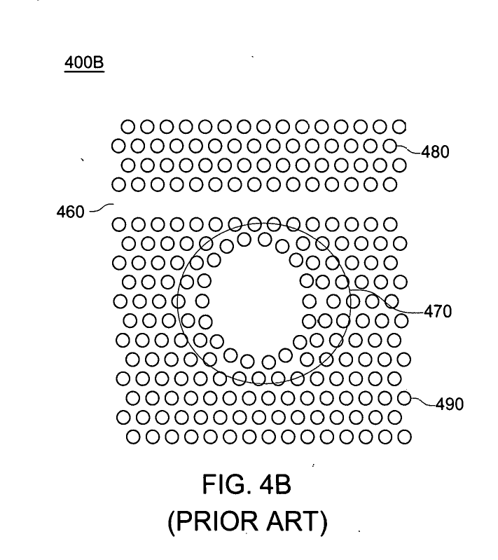

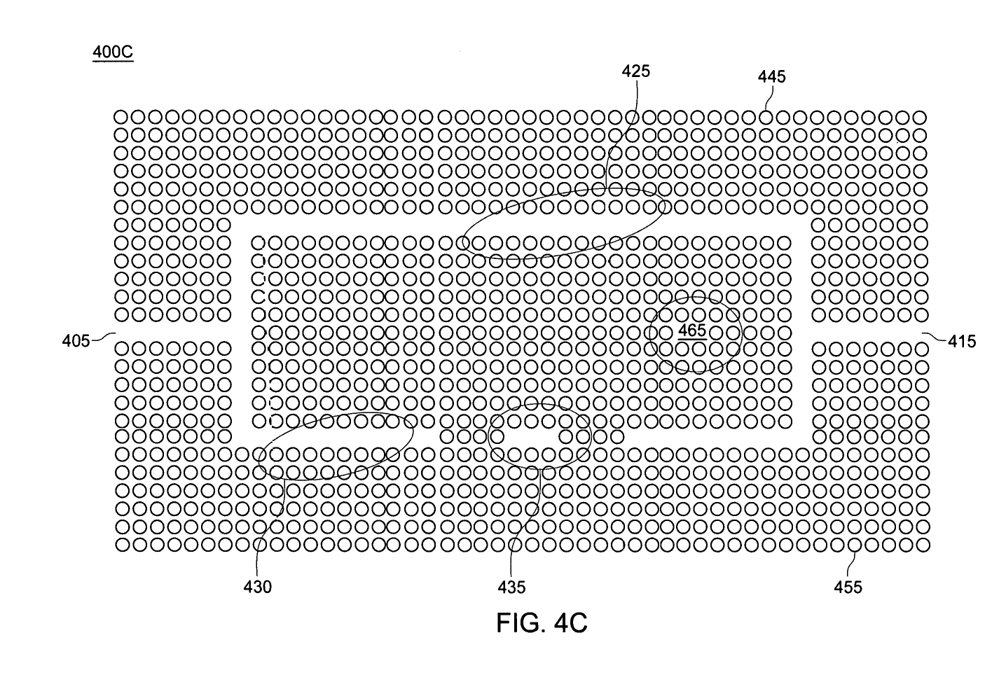

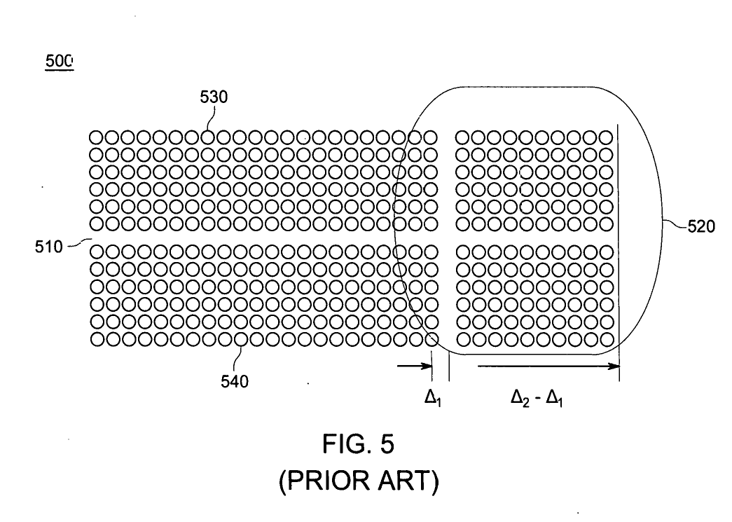

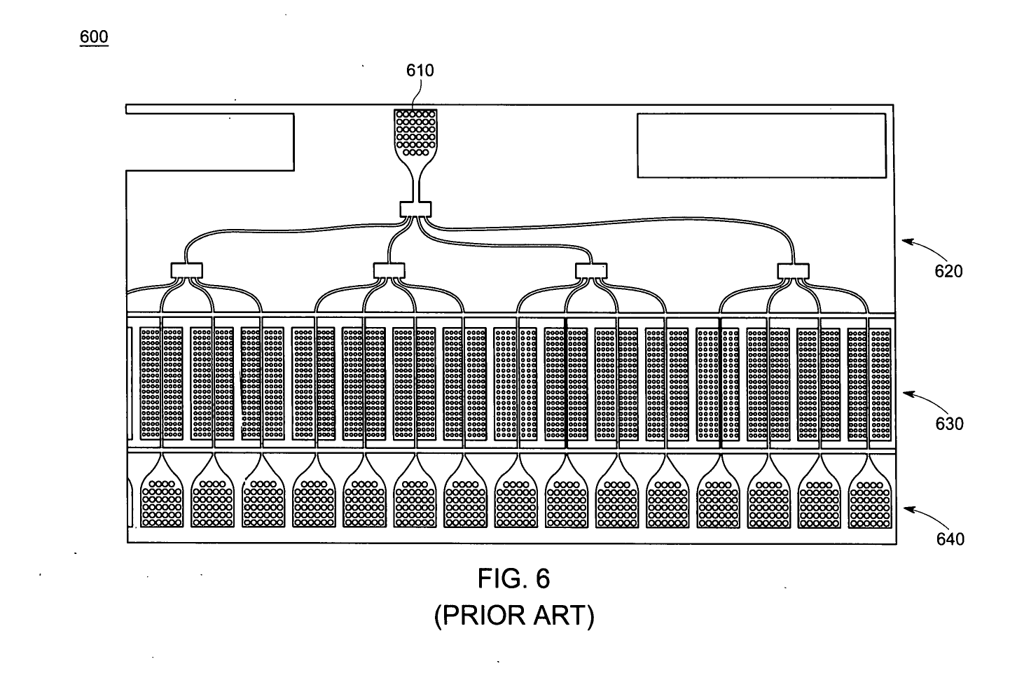

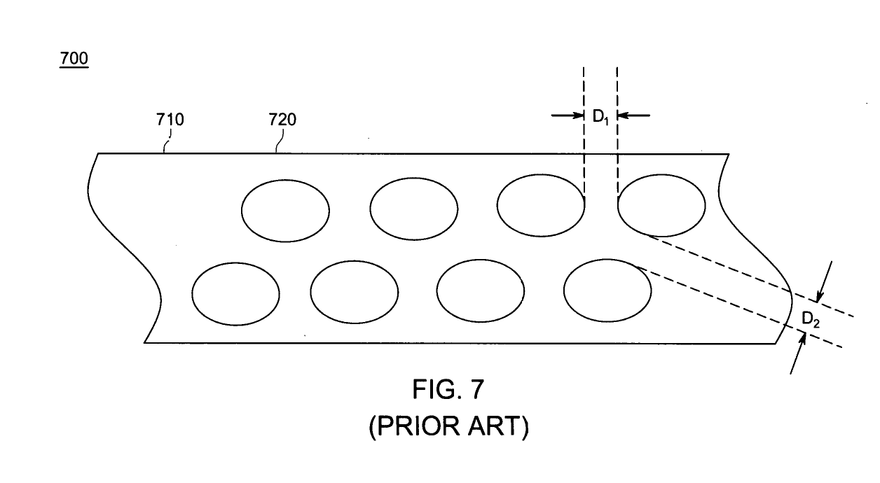

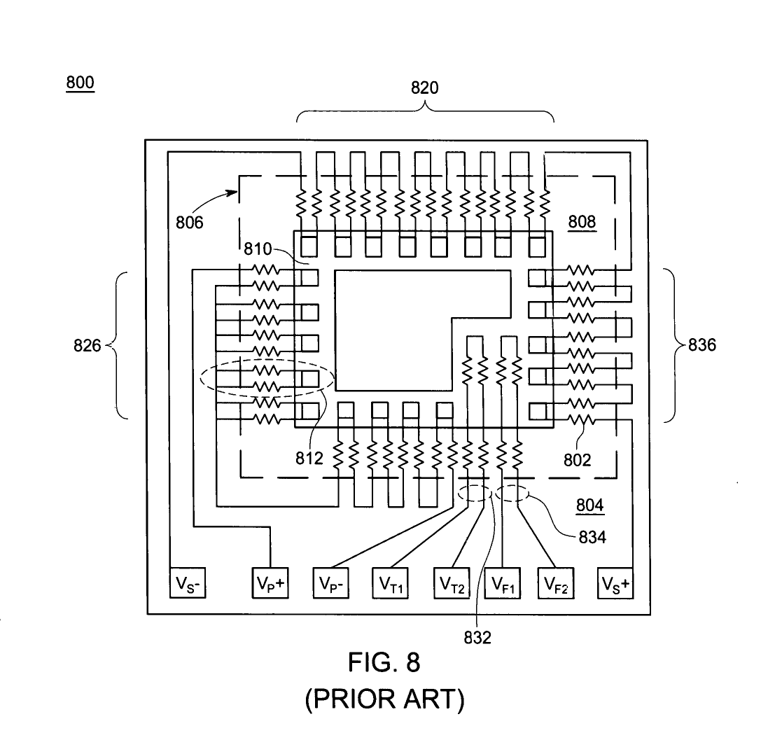

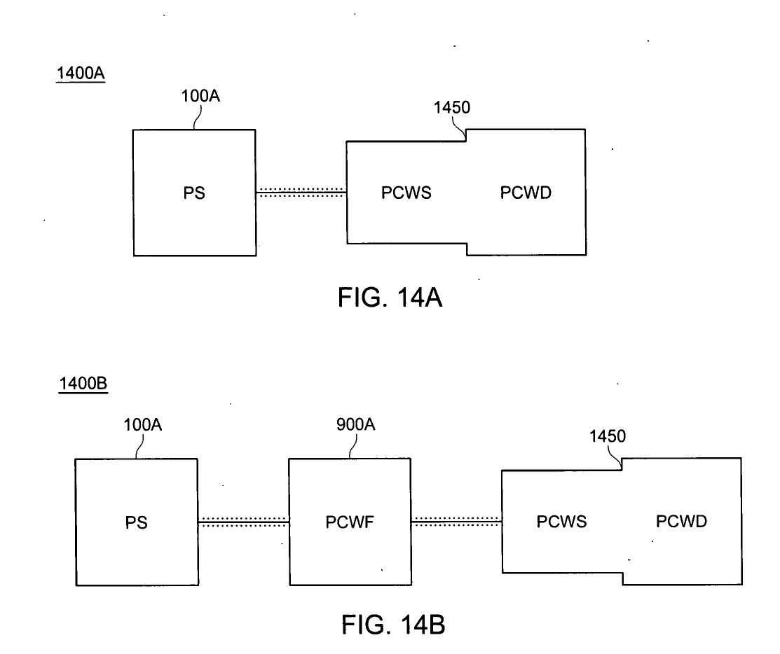

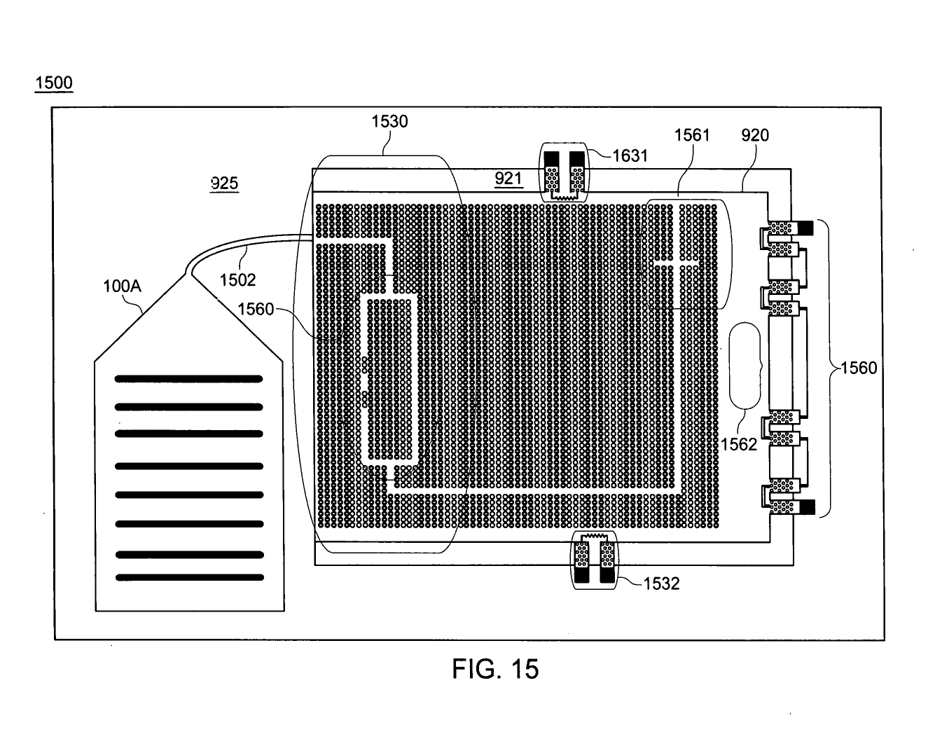

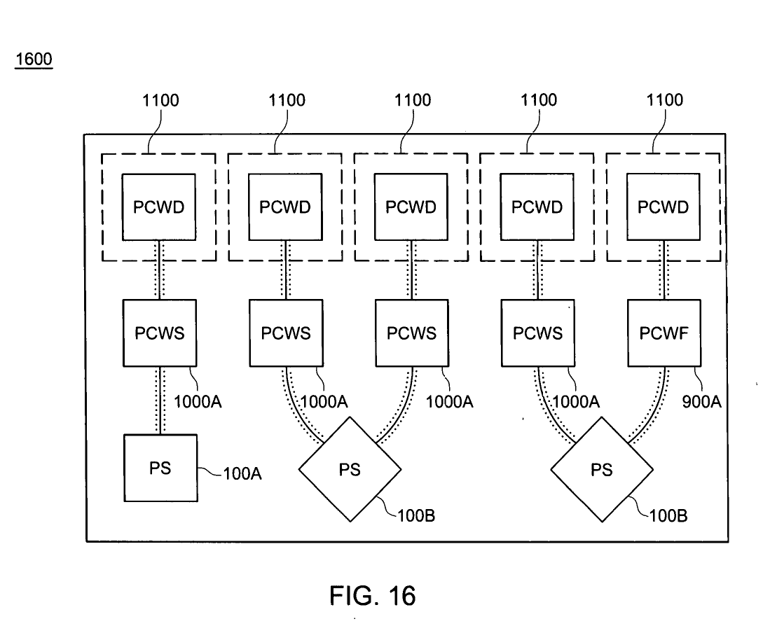

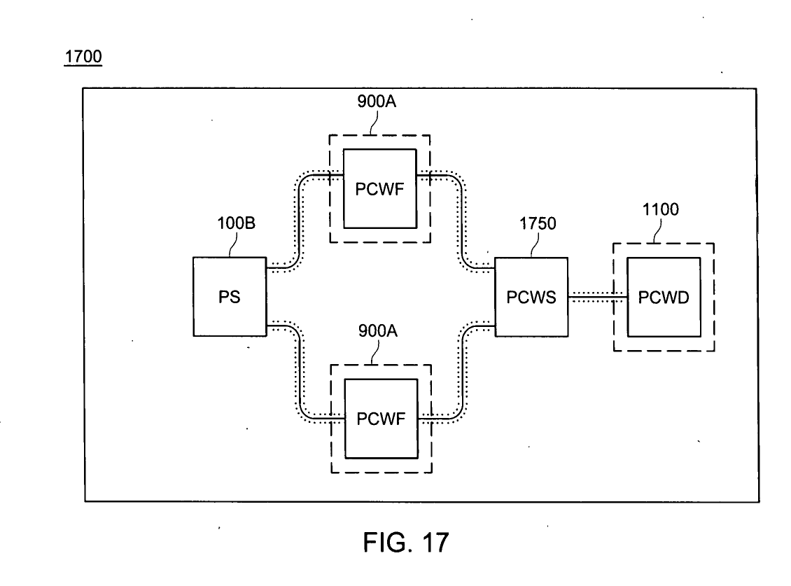

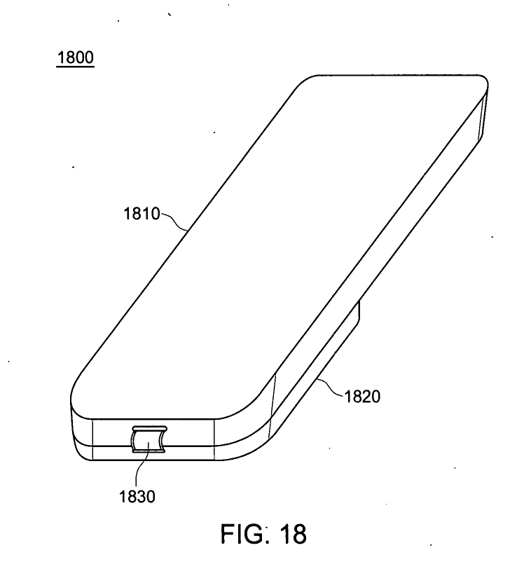

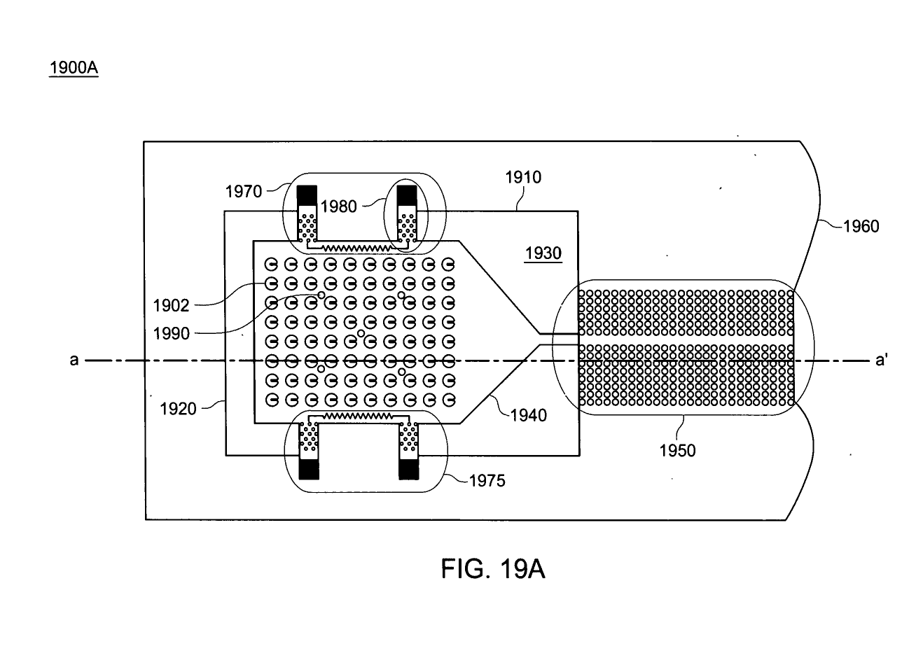

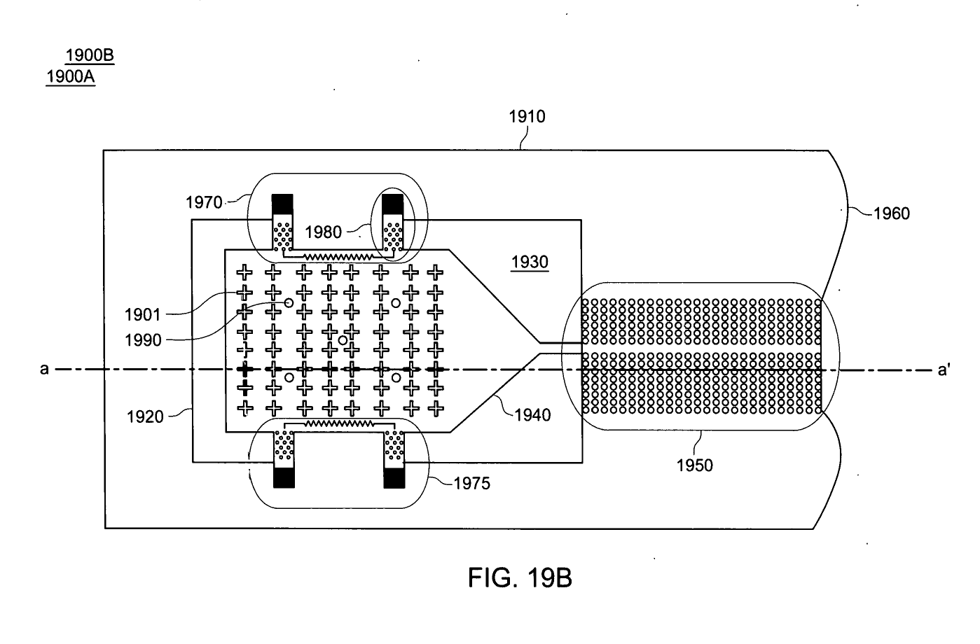

FIG. 14A with a grating photonic source PS with a single micro-platform providing both a Mach-Zehnder sensor PCWS and the photonic crystal waveguide detector PCWD.

FIG. 16 is a schematic depicting a chip comprising four photonic sources, five photonic crystal waveguide sensors PCWS and five photonic crystal waveguide sensors PCWD structures in accordance with embodiments of the invention.

FIG.17 is a schematic depicting a chip comprising a photonic source PS, dual photonic crystal waveguide filters, a photonic crystal waveguide sensor PCWS and a photonic crystal waveguide detector PCWD in accordance with embodiments of the invention.

FIG.18 depicts a photonic waveguide sensing apparatus disposed on the backside of a mobile telephone in accordance with embodiments of the invention.

FIG.19A depicts a plan view of a metamaterial photonic source with linear-type plasmonic emitter comprised of a structured array of antenna cells creating a photonic wave coupled into a photonic crystal waveguide with a slab core in accordance with embodiments of the invention.

FIG. 19B depicts a plan view of a metamaterial photonic source with circular-type plasmonic emitter comprised of a structured array of antenna cells creating a photonic wave coupled into a photonic crystal waveguide with a slab core in accordance with embodiments of the invention

FIG. 19C depicts a cross-section view of the photonic sources of FIGS. 19A and 19B.

### DETAILED DESCRIPTION

Definitions: The following terms are explicitly defined for use in this disclosure and the appended claims:

“infrared” or “IR” refers to light of wavelength 700 nm to 1000 micrometers. In this spec infrared is also referred to as “photonic” or “optical”.

“analyte” refers to a gas, vapor, particulate or biomolecular material exposed to the photonic crystal waveguide sensor for the purpose of identification or monitoring.

“analyzing” refers to monitoring, identifying, or otherwise processing the signal provided to the detector as modulated by the analyte.

“support” layer refers to one or more layers that, in some embodiments, are disposed above or below the active layer. This layer or layers are generally low loss material and have a lower dielectric constant compared to the active layer. This layer can be formed from the “buried oxide” layer of a semiconductor-on-insulator wafer.

“supported by” means that, for example, one layer is supported by, but not necessarily disposed on, another layer. For example, a micro-platform is supported by tetherbeams which may not be disposed in or on the micro-platform.

“micro-platform” refers to a patterned layer having an overall dimension of about 100 nm up to about 1 cm. The micro-platform is generally an isothermal structure thermally isolated from a surrounding support layer.

“tetherbeam” refers to the suspended support structures with terminations disposed on the surrounding-support platform and a micro-platform.

“IR source” or “infrared source” means a radiation source typically comprised of one or more of a laser, LED, fiber optic, heated membrane, or metamaterial plasmonic emitter.

“photonic structure” refers to a dimensioned structure for sourcing, interfacing, coupling, focusing, guiding, switching, terminating and sensing a photonic wave.

“phononic structure” refers to a dimensioned structure for sourcing, interfacing, coupling, scattering, resonating and sensing conductive heat.

“grating coupler” means the photonic structure which couples an IR source into a photonic waveguide or a photonic crystal waveguide.

“photonic waveguide or PW” in this invention refers to a traditional 2-D or 3-D photonic structure for guiding a photonic wave through a core pathway surrounded by cladding of a lower effective index of refraction.

“photonic crystal waveguide or PCW” in this invention refers to a photonic guide comprised of a a core guided photonic pathway surrounded by a 2-D or 3-D periodic photonic crystal cladding structure.

“photonic crystal waveguide sensor or PCWS” refers to a sensor element comprised of photonic crystal waveguide structures sensitive to changes in the refractive index of a proximal media. The PCWS may or may not be disposed on a thermally-isolated micro-platform.

“photonic crystal waveguide filter or PCWF” refers to a filter element comprised of a photonic crystal waveguide structured to limit or shift the bandwidth of the photonic wave propagating through.

“photonic crystal waveguide detector or PCWD” refers to a photonic detector element comprised of a photonic crystal waveguide with thermally-dispersive structures providing a thermal means of detecting and monitoring an input photonic signal. The PCWD element is comprised of supporting tetherbeams having thermal-conductivity reducing structures.

“active layer” refers to the dielectric layer comprising the core guide within a filter PCWF, sensor PCWS or detector PCWD. In this invention, the active layer is generally the device layer of an SOI wafer.

“photonic zero-reflection termination” refers to the thermally-dispersive termination for the photonic crystal waveguide PCW contained within a PCWD element.

“integrated photonic and phononic structure or IP&P ” refers to a coupling structure comprised of a tetherbeam for a micro-platform comprised of both photonic and phononic structures. It is further comprised of at least one photonic PW or PCW guide and phononic thermal conductivity-reducing structures. In emodiments the IP&P may also provide a galvanic connection to sensor or heating elements on a micro-platform.

“active layer” refers to the primary layer comprising the PCW. This layer may be comprised of a plurality of layered thin films.

“SOI” refers to a wafer comprised of a semiconductor topside device layer, an intermediate oxide film, and an underlying handle substrate. In the case of silicon SOI the three layers are silicon device, silicon dioxide and silicon handle layers.

“thermoelectric device or TED” refers to a device converting a temperature differential or absolute temperature into an electrical voltage. The TED may be of a passive-type such as a bolometer, semiconductor bandgap diode, thermistor, Peltier cooler or resistive heater, or, alternatively, it may be of an active-type such as a Seebeck thermocouple sensor.

“bolometer” refers to a passive thermoelectric sensor, comprising material such as vanadium oxide, with a resistance to AC current flow that is proportional to incremental changes in temperature

“spectrophotometer” refers to an instrument providing a measurement of optical power within one or more wavelength components of an optical beam.

The photonic source PS in this invention is generally comprised of a Bragg-type grating providing a photonic signal into a tapered slab waveguide. The tapered waveguide is required to downsize the cross-section of the beam to match the smaller entrance structure of a PCW which further guides the photonic signal through to a detector disposed within the spectrophotometer. Off-chip infrared emitters include one or more of a laser, especially a quantum cascade laser (QCL), LED, OLED, fiber optic, heated membrane or plasmonic emitter. These sources including plasmonic sources having metamaterial blackbody emitters with resonant plasmonic filter structures are well known to those skilled in the art.

In some embodiments the photonic source PS element is comprised of an off-chip photonic emitter having a photonic beam transmitted through, backscattered from or reflected from an analyte such as a gas, vapor, particulate, biomolecular mass or surface. In these embodiments radiation originating off-chip is focused onto an on-chip grating.

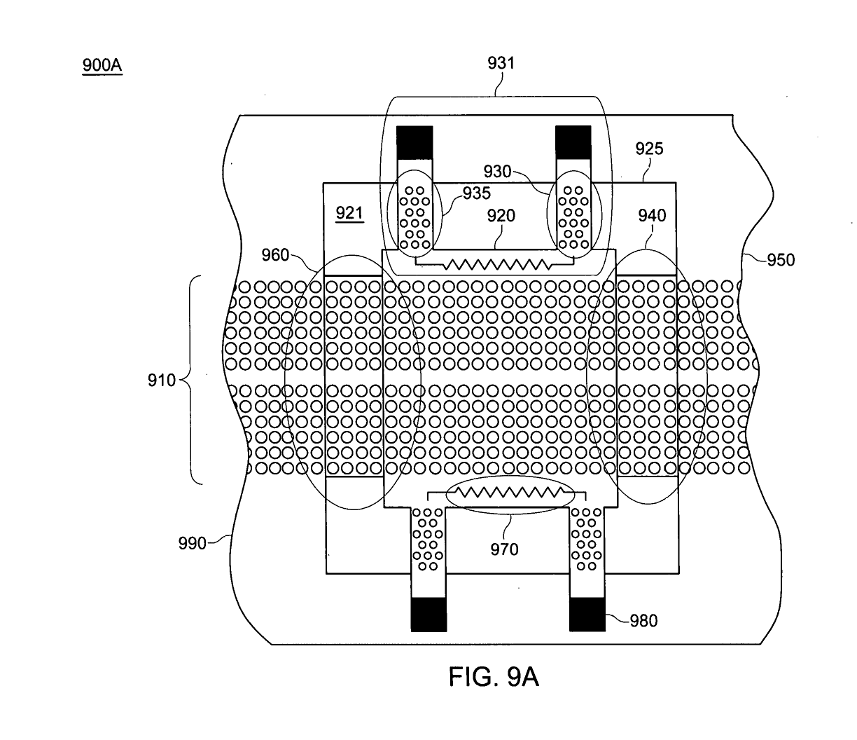

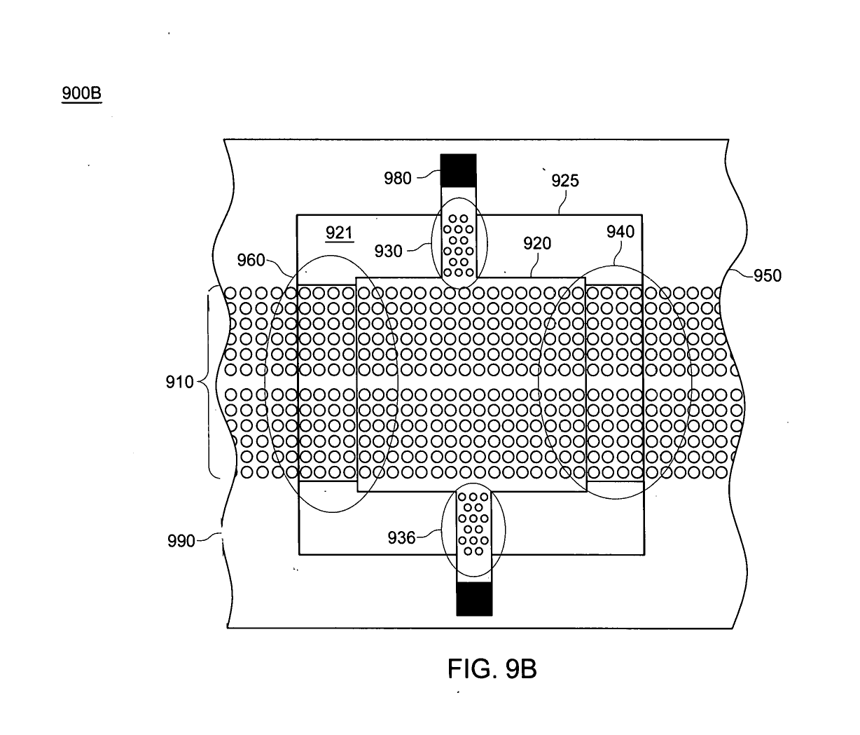

FIG. 9A depicts a photonic crystal waveguide filter PCWF element disposed on a micro-platform 920. In this structure a PCW 910 with appropriate structuring is disposed between the entrance port 990 and exit port 950 of a micro-platform 920. The PCW I in this illustrative embodiment is comprised of a slab-type core guide. The micro-platform 920 is comprised of a central core of the PCW, a heating element within heater 931 and a thermistor 970. A cavity 921 bounded by a surrounding support platform at perimeter 925 extends underneath the micro-platform 920. A plurality of tetherbeams such as tetherbeam 930 and the underlying cavity 921 provide thermal-isolation to the microplatform. Tetherbeams at the entrance port 990 and exit port 950 are comprised of integrated photonic and phononic IP&P structures 960 and 940. These IP&P structures are adapted to provide a tetherbeam comprised of a guide PCW with structures further providing a reduced-thermal conductivity for the micro-platform 920.

In the illustrative embodiment of FIG. A and FIG. 9B, the micro-platform 920 is heated with a resistive heater 931 connected to an external voltage source through separate electrically-conducting tetherbeams 930 and 931. These tetherbeams have an internal structure providing a reduced thermal conductivity. Micro-platform temperature is monitored with a thermistor 970 connected via electrically-conducting tetherbeams to bonding pads illustrated by pad 980.

FIG. 9B depicts another embodiment of a photonic crystal waveguide filter PCWF, similar to that of FIG. 9A, except that the resistive heater element is disposed orthogonally with respect to the PCW. In this embodiment the electrical resistivity of the active layer comprising the micro-platform 920 provides an electrical resistor between the galvanic connection provides through tetherbeams 930 and 936. The heater is powered from an external voltage source connected through a bonding pad 980 and another on tetherbeam 936.

The filter PCWF of FIG. 9A in this embodiment is fabricated from a starting silicon SOI wafer. The photonic crystal waveguide PCW, tetherbeams, and micro-platform 920 are formed of an active layer of a starting wafer. In this embodiment the silicon device layer of the starting SOI is typically of high resistivity. The thermoelectric galvanic circuit paths within tetherbeams and in the micro-platform are created by impurity doping using a spin-on dopant such as B, P, or As with lift-off lithography patterning. Doping of the tetherbeams is performed typically using a spin-on dopant with lift-off patterning followed by a contact etch and a sputtered aluminum contact 960 and further appropriate patterning.

Next, the silicon device is fully or partially covered with a stress relief layer of silicon nitride from a CVD deposition process using a silane and ammonia precursor. This stress relief layer also provides an upper cladding film covering the integrated IP&P coupling structures 940 and 960. The resulting film topside of the silicon buried oxide layer is selectively patterned using a DRIE plasma and deep submicron lithography. Finally the micro-platform is released from the silicon handle wafer using an HF-vapor etch. The processing technology for fabricating the photonic devices of this invention is well known to those skilled in the art of semiconductor device fabrication and MEMS.

In other embodiments cladding films external to the plane of the photonic core are comprised, without limitation, of one or more of silicon dioxide, silicon nitride, aluminum oxide, PDMS, and PMMA. In some embodiments, the active layer is comprised,without limitation, of silicon, germanium, gallium arsenide, indium arsenide, gallium nitride and alloys thereof.

In embodiments the PCWF element is operated as a thermally-controlled gating switch or bandwidth tuning filter. The guide PCW within a filter PWCF in embodiments may be structured to provide slow-wave operation to provide a phase delay for the photonic signal. In some embodiments a PCWF element is disposed directly onto the dielectric layer of a SOI wafer without a micro-platform or temperature control. In embodiments one or more active layer or layers are comprised, without limitation, of silicon, germanium, gallium arsenide, indium arsenide, gallium nitride vanadium oxide, zinc oxide and alloys thereof including materials where the refractive index is sensitive to temperature.

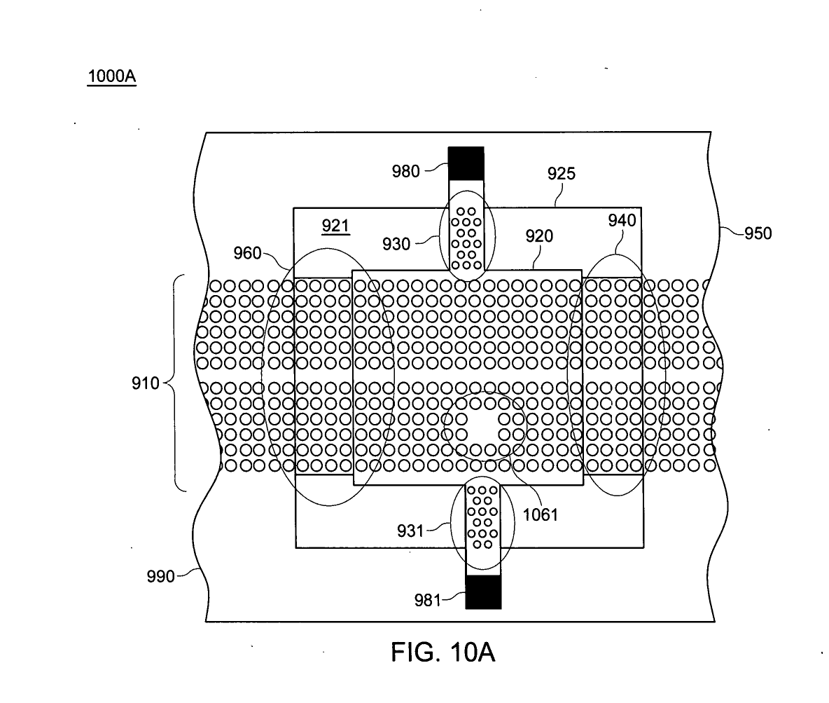

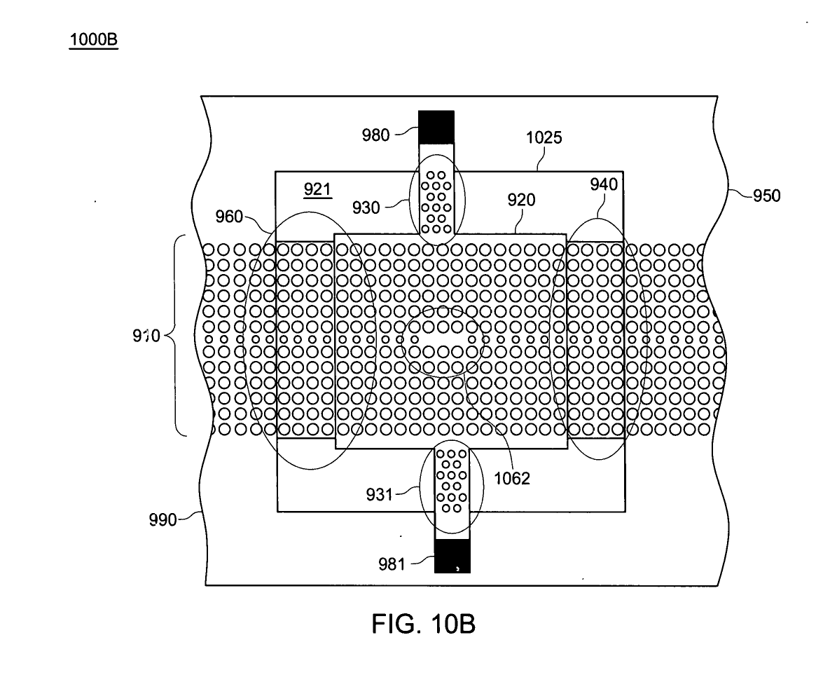

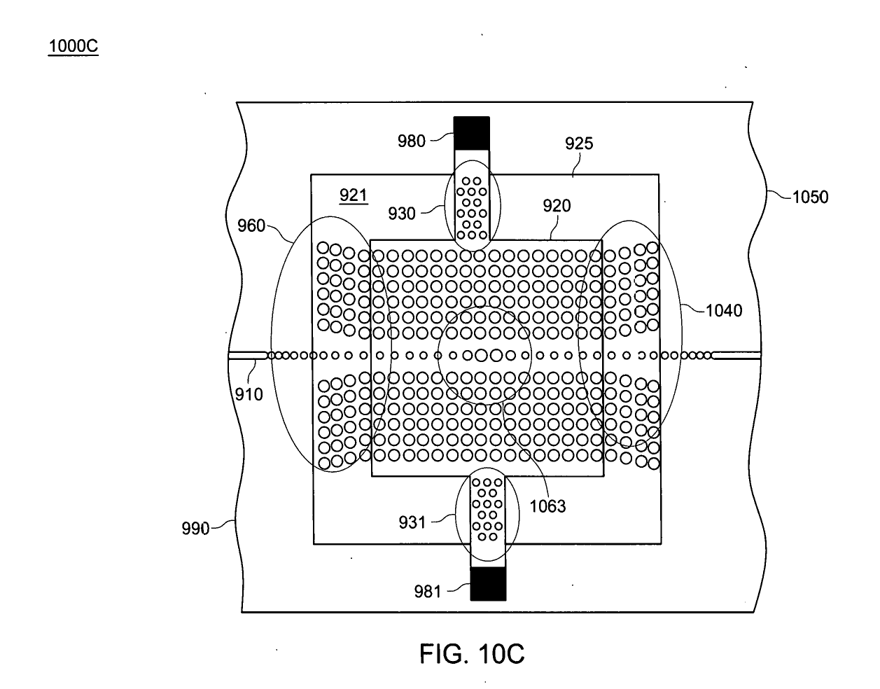

FIGS. 10A, 10B and 10C depict representative embodiments of photonic crystal waveguide sensor PCWS elements comprised of guide PCW 910. A photonic signal enters the PCW 910 at port 990, proceeds successively through a first integrated IP&P structure 960, on to the PCW sensing area having a high-Q sensor structure within the PCW, continues into a second integrated IP&P structure 940 or 1040 and exits at port 950. The integrated IP&P structures 960 and 940/1040 are disposed on tetherbeams. The micro-platform and all tetherbeams including 930 and 931 are disposed over cavity 921.

In this embodiment the guide PCW formed within the micro-platform is operated in a slow-wave mode to provide a maximum sensitivity with exposure to an analyte of interest. The periodic holes in the cladding structure of a PCW create a negative index dispersion at an infrared wavelength of interest which significantly reduces the group velocity for a wave propagating through a core guide path. In the illustrated PCWS embodiments the group velocity of the propagating wave through the core is significantly delayed with respect to free space propagation. In embodiments of this invention the guided wave core may be a slab, holey or slot-type. The amplitude of the signal exiting the sensor PCWS is modulated by an analyte exposed to a high-Q resonator disposed within the PCW 910 and micro-platform 920. In these embodiments tetherbeams 930 and 931 provide a galvanic connection to a resistive heater disposed on the micro-platform 920.

The sensor PCWS of FIG. 10A depicts embodiment 1000A and is comprised of a single illustrative high-Q resonator 1061 imbedded in the cladding area of guide PCW 910. The resonator is electromagnetically coupled to the evanescent tail of the slow-wave propagating through the guide PCW slab core. Quality factors of 10,000 and higher are achieved with these resonant structures. The resonator provides a high sensitivity to nearby minute changes in refractive index when exposed to an analyte of interest.

The sensor PCWS of FIG. 10B depicts embodiment 1000B comprised of a single high-Q resonator 1062 disposed in the PCW core and electromagnetically coupled to the slow-wave propagating through the core. In this illustrative embodiment 1000B the core guide is of holey type. In this embodiment the optical signal propagates through from entrance port 990 and through a PCW 910 to exit port 950. The photonic transmission through the sensor PCWS is very sensitive to an analyte on or near the high-Q cavity 1062.

The PCWS of FIG. 10C depicts another embodiment of a sensor PCWS element wherein the guide PWC 910 is comprised of a holey core and interfaces with a standard slab waveguide PC at the entrance 990 and exit 950 ports. A central area 1063 within the holey PCW core is comprised of increasing and decreasing hole diameters providing an increased sensitivity upon exposure to an analyte of interest. The discontinuity introduced by structure 1063 in the optical path is sensitive to small changes in refractive index presented by an analyte disposed in or near the sensitive core area 1063.

An incremental shift in the distance of holes in the cladding area of the integrated IP&P couplers 960 and 1040 provides a desirable photonic impedance match between the central PCW and the conventional slab waveguide 910. The impedance matching structure of IP&P tetherbeams 960 and 1040 depicted by the in FIG. 10C can be used in this and other embodiments of this invention wherein a non-reflecting coupling of signals between waveguides of different structure and type is desired.

Processing of the sensor PCWS element depicted in the embodiments of FIG. 10A, 10B and 10C is similar to that of the illustrative examples in FIG. 9. In embodiments the sensor PCWS element is adapted further, generally with the addition of unique mechanical structures, to control exposure and transport of an analyte of interest to the sensor element.

In some embodiments a PCWF element is disposed directly onto the dielectric layer of a SOI wafer without a micro-platform or temperature control

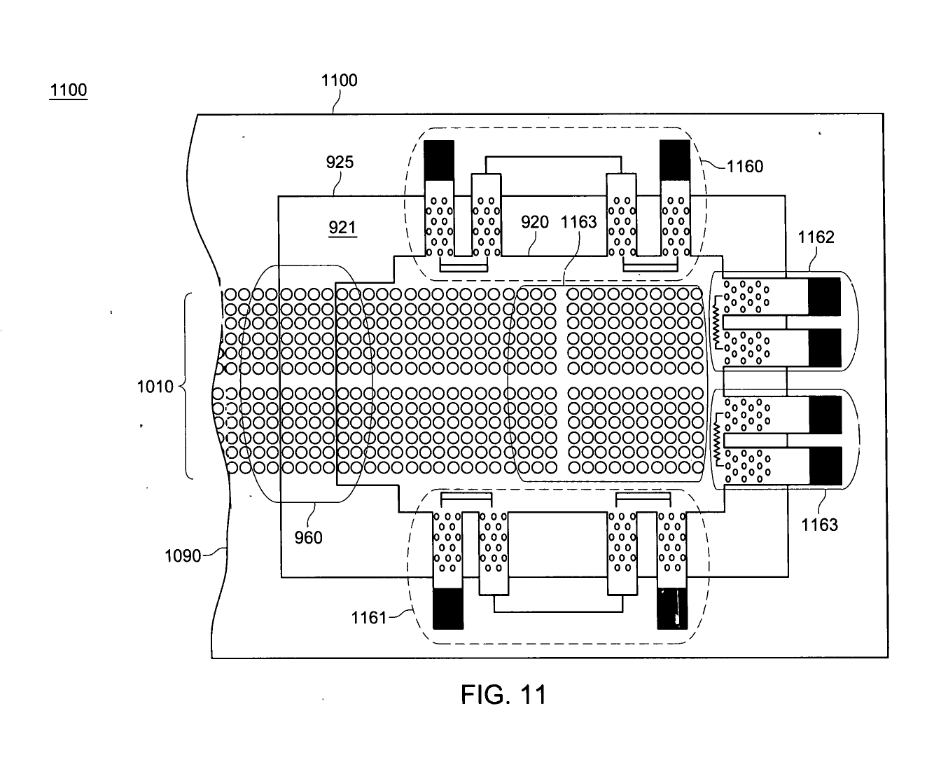

FIG. 11 depicts a photonic crystal waveguide detector PCWD element comprised of a photonic crystal waveguide PCW terminating into a dissipative photonic crystal structure. In this sensor a photonic signal enters the PCWD through guide 1010 at entrance port 1090 and propagates through integrated IP&P 960 into the micro-platform 920. The integrated IP&P structure provides a coupling from off-platform to on-platform sections of the PCW 1010. The PCW 1010 is terminated on-platform into a resonant-Bragg absorbing structure 1163 disposed within the PCW 1010. The underlying cavity 921 is bounded by the surrounding support structure 925. In other embodiments, the dissipative termination structure may be comprised of one or more of coupled resonant RLC loops, low-Q photonic crystal resonators, and a field of nanotubes. The dissipative structure 1163 converts the optical power delivered by the PCW 1010 into heat which increases the temperature of the isothermal micro-platform structure 920. The incremental increase of temperature of the micro-platform 920 is proportional to the optical power delivered to the termination 1163.

The detector PCWD of FIG. 11 is further comprised of several sensing and control devices. The incremental temperature increase of the micro-platform 920 due to absorbed photonic signal is sensed with a series connection of Seebeck thermoelectric devices 1160. The micro-platform is heated with a resistive device 1162 powered from an external voltage source and is monitored with thermistor device 1163. The micro-platform is cooled with series connection of Peltier thermoelectric devices 1161 powered from an external voltage source. The detector PCWD of FIG. 11 is fabricated using processes similar to those used for the filter PCWF and sensor PCWS.

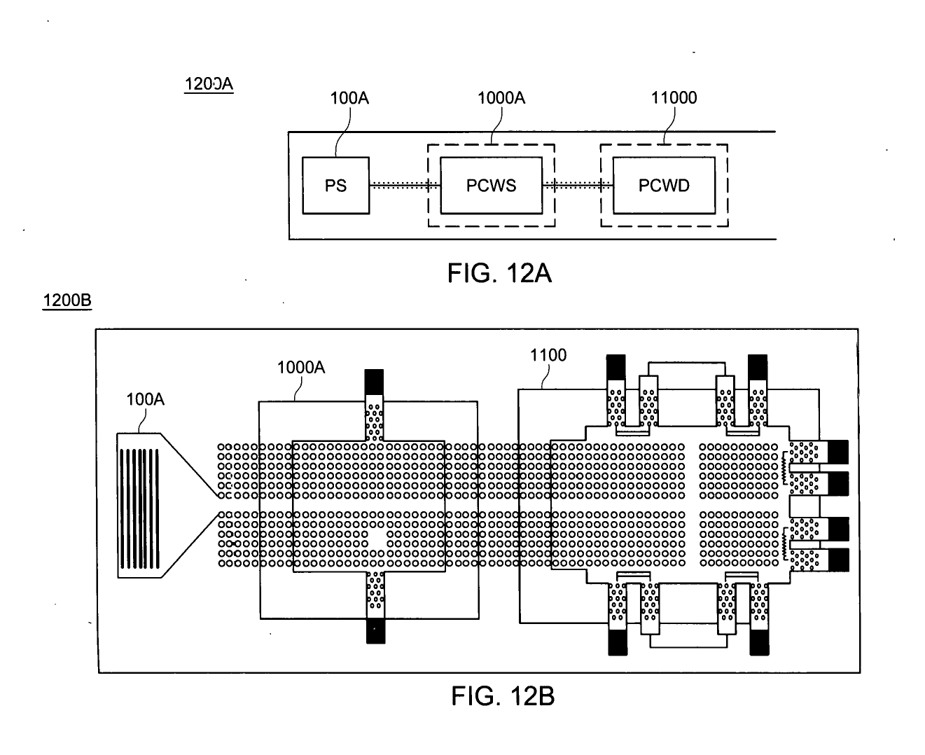

FIG. 12A and 12B depict a spectrophotometer chip having three elements comprised of a source PS 100A, a sensor PWCS 1000A and a detector PCWD 1100. The source 100A is a 1-D Bragg grating with a tapered slab waveguide feeding a photonic signal into a PCWS 1000A followed by a PCWD 1000. The sensor PCWS and the detector PCWD are disposed on separate micro-platforms. This embodiment is comprised of three integrated IP&P couplings onto and off micro-platforms. In applications this embodiment provides a spectrophotometer sensitive to an analyte exposed to the sensor PCWS 1000A. The Bragg grating 100A is an example of a photonic source PS element which in this embodiment is further comprised of an external laser, LED, OLED, incandescent or metamaterial filtered blackbody emitter.

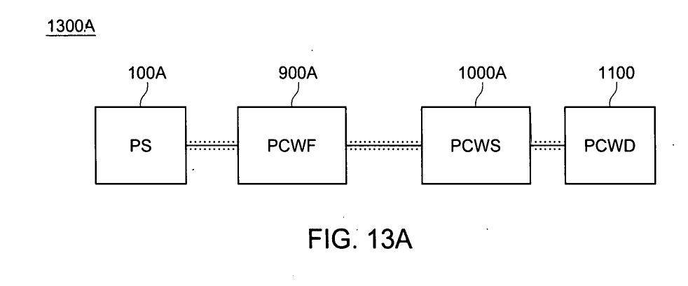

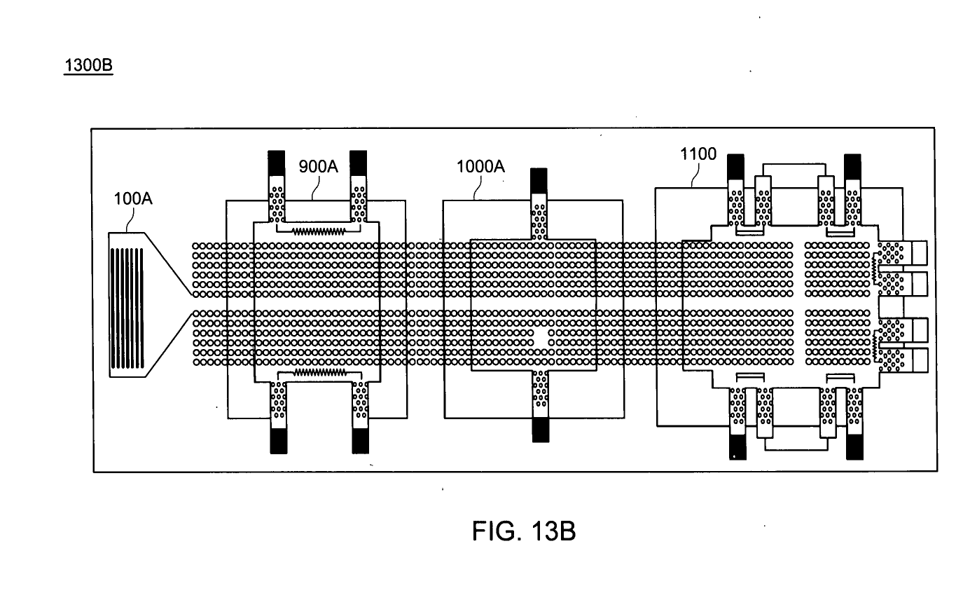

FIG. 13A and 13B depict a a spectrophotometer chip having four elements. A source PS 100A originates a photonic signal which propagates through filter PCWF 900A and a sensor PWCS 1000A with termination into detector PCWD 1100. This embodiment three micro-platforms are linked through five couplings IP&P. In applications this embodiment provides a spectrophotometer sensitive to an analyte exposed to the sensor PCWS 1000A. The chip is processed using cleanroom tools and processes well known to those skilled in the art.

FIG. 14A depicts a spectrophotometer chip with a source PS 100A and a single micro-platform 1450. A source PS is connected via a guide into a structure which integrates a sensor PCWS element and a detector PCWD element into a single micro-platform 1450.

FIG. 14B depicts a spectrophotometer chip with a source PS 100A and two micro-platforms. A source PS 100A element provides a signal through a guide to filter 900A element and on to integrated sensor and detector elements. A first micro-platform comprises a filter PCWF 900A. A second micro-platform comprises the integrated sensor PCWS and detector PCWD (1450).

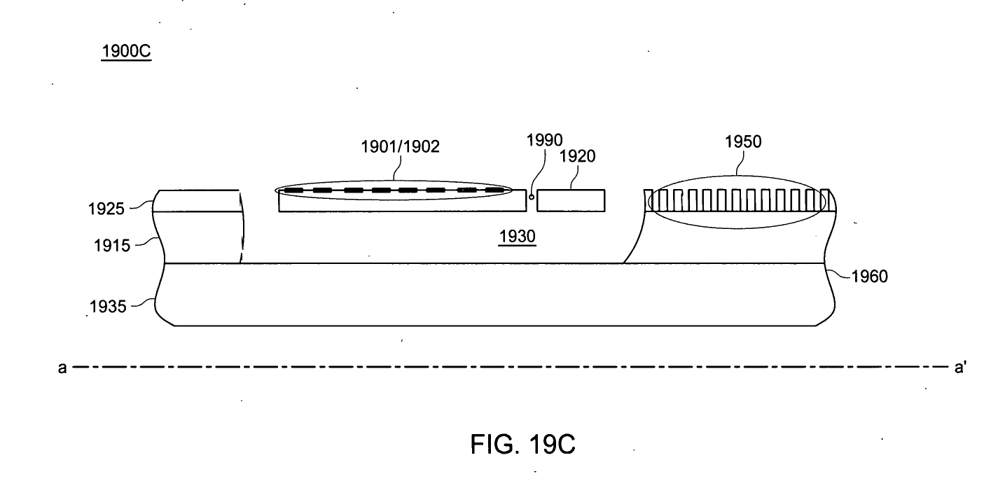

FIG. 15 is a plan view 1500 depicting the spectrophotometer of FIG. 14A. Source PS 100A provides signal through a slab waveguide coupled into the photonic crystal waveguide PCW of a sensor PCWS 1560 element. After the photonic signal is conditioned in the sensor PCWS element it propagates through a PCW guide onto a detector PCWD disposed on micro-platform 920. The sensor PCWS 1560 element is of Mach-Zehnder type and is disposed within an IP&P coupler disposed on a tetherbeam of micro-platform 920. The detector PCWD is comprised of a resonant-Bragg termination 1561 disposed on the micro-platform 920. The micro-platform is thermally isolated from a surrounding support platform 925 by the several tetherbeams comprising the sensor PCWS element and other tetherbeams comprising various thermoelectric devices. Two in-line high-Q resonant cavities disposed within one of two core guides within the M-Z interferometer provide a differential sensitivity to an adjacent analyte of interest.

The Mach-Zehnder interferometer of FIG. 15 is disposed immediately adjacent to the surrounding support structure 920 which is heat sinking and therefore is maintained at a constant temperature compared with the micro-platform. The dissipative termination 1561 disposed on the thermal micro-platform 920 is effectively thermally-isolated from the surrounding support platform 925 by phononic structuring of the micro-platform 920 and tetherbeams. Structural examples of such phononic structuring is disclosed in prior art such as U.S. Pat. No. 9,236,552. The integrated structures of FIG. 15 effectively thermally isolate the M-H sensor from the dissipative termination 1561 as required for proper spectrophotometer operation.

In FIG. 15 additional devices 1631 and 1532 comprising tetherbeams and on-platform resistors provide a heater 1531 and a thermistor 1532. An array of Seebeck thermoelectric devices 1160 senses the incremental temperature differential between the PCW termination 1561 structure and the surrounding support platform 925. The unpatterned area 1562 of the micro-platform 920 provides a desirable increased thermal coupling between the termination structure 1561 and the Seebeck thermoelectric array 1160.

The schematic of FIG. 16 depicts an integration of multiple photonic functions on chip 1600 providing a further complex spectrophotometer function. In this embodiment three photonic sources PS 100A and PS 100B provide a signal through photonic guides to a a plurality of sensor PCWS 1000A elements and a filter PCWF 900A element. Each sensor PCWS element provides a signal modulated by an analyte to a detector PCWD 1100 element. The source PS 100A with optical fan-out=1 provides for a non-differential sensing of an analyte. The source PS 100B structured with an optical fan-out=2 provides for a differential sensing of an analyte.

The schematic of FIG. 17 depicts another spectrophotometer chip embodiment comprised of two filter PCWF 900A elements which in some embodiments provides a thermal on/off switch of the photonic beam originating from the source PS 100B. This chip in embodiments provides for implementing a form of synchronous detection using the filter PCWF elements as switches. In other embodiments the two filter PCWF elements 900A provide a thermal means of tuning the center bandwidth wavelength of the two filter PCWF elements separately. The signal gated or tuned by the two filters PCWF next propagates through a sensor PCWS 1750 element and on into a detector PCWD 100 element. This chip in embodiments provides for implementing multi-wavelength spectral analysis of an analyte exposed in the PCWS 1750. In this embodiment the detector PCWD 1100 is designed with adequate bandwidth to dissipate signals from the PCWS 1750 over an adequate wavelength range.

The oblique view of FIG. 18 depicts an application comprising the spectrophotometer configured as an apparatus 1820 attached to a mobile phone 1810. The spectrophotometer communicates with and receives DC power from the mobile phone typically through a micro-USB bus 1830.

FIGS. 19A and 19B depict plan views and FIG. 19C depicts a cross-section view of metamaterial plasmonic photonic sources PS disposed on a micro-platform 1920 providing a photonic signal into a tapered slab waveguide 1940 and further into a guide PCW 1950. The guide PCW 1950 provides an optical signal from the exit port 1960 forward into appropriate filters and sensors disposed within the spectrophotometer chip. Excitation for the photonic source is derived from thermal heating of the micro-platform 1920 through resistive heaters 1970 and 1975. The photonic emission results from localized magnetic and dipole resonances excited by the thermal surface energy coupling to the metallic surface structures. In this emitter a plurality of depicted tetherbeams 1980 provide a galvanic connections to resistive heaters patterned into the micro-platform 1920.

The photonic sources PS 1900A and 1900B are comprised of a periodic array of metamaterial metallic resonators disposed on the active region of the micro-platform 1920. The blackbody spectrum of radiation from the surface areas of the photonic source is filtered by and in certain cases enhanced by the plasmonic resonances of metamaterial resonators 1901 and 1902. These plasmonic electromagnetic fields are controlled by the size and shape of the metallic surface resonators in addition to the permittivity and temperature of the underlying micro-platform.

Photonic sources PS 1900A and 1900B with blackbody filtering resonators 1901 and 1902 are fabricated using cleanroom processes similar to those used for other micro-platform structures of the invention. A processing difference is that the patterned metamaterial metallic resonators 1901 and 1902 are created onto the device layer requiring additional processing steps. Open holes 1990 in the device layer are patterned topside through the device layer to facilitate etch removal of the underlying oxide and release of the micro-platform to create an underlying cavity 1930. The open holes 1990 are not required when the micro-platform is released using a patterned backside TMAH, KOH or DRIE etch. The metamaterial resonators are comprised typically of appropriate patterned metal films such as aluminum, gold, tungsten or silver. In some embodiments a different 501 starting wafer is comprised of a BoX dielectric layer such as aluminum oxide.

The metamaterial resonators within photonic sources 1900A and 1900B are dimensioned respectively as a cross and an semicircle. There are in addition a great variety of resonator shapes that can be appropriately dimensioned for this embodiment.

FIG. 19C depicts a view cross-section a-a′ of emitters 1900A and 1900B depicting the a released micro-platform 1920 and a underlying topside-etched cavity 1930. The device layer is patterned to create the micro-platform 1920, the PCW 1950 and a surrounding support area 1925. The output port 1960 is physically connected to selected photonic devices such as a sensor PCWS or the filter PCWF. A buried oxide (BoX) layer 1915 of a starting silicon SOI wafer is sandwiched between the device layer 1925 and a handle wafer 1935. In some embodiments the PCW 1950 is disposed in a tetherbeam attached to the micro-platform 1920. The PCW when disposed withinin a tetherbeam comprises an integrated IP&P structure.

Spectrophotometer Adapted for Backscattered Infrared

In some embodiments the photonic source PS for the spectrophotometer is backscattered infrared from an external analyte. In this embodiment an infrared source illuminates an external analyte and a collector lens focusses a backscatter beam into the on-chip photonic grating. The resulting photonic signal is processed through a PCWS sensor which in this case provides a wavelength filter for signal into the PCWD detector. Specific wavelength of the backscatter are analyzed to identify or monitor species in the analyte typically a remote gas or vapor.

It is to be understood that although the disclosure teaches many examples of embodiments in accordance with the present teachings, many additional variations of the invention can easily be devised by those skilled in the art after reading this disclosure. As a consequence, the scope of the present invention is to be determined by the following claims.

What is claimed:

1. An infrared spectrophotometer apparatus comprised of at least one each of a photonic source (PS) element, a photonic crystal waveguide sensor (PCWS) or photonic crystal filter (PCWF) element and a photonic crystal waveguide detector (PCWD) element disposed on a chip, and with the chip further comprised of one or more of an integrated photonic and phononic coupler (IP&P) wherein
each coupler IP&P is disposed proximally with a micro-platform;
a photonic signal originating from a photonic source PS element is guided through one or more of a sensor PCWS element and/or a filter PCWF element and continues further into a detector PCWD element and
the detector PCWD element is comprised of a thermoelectric sensor and a thermally-dissipative termination.

2. The apparatus of claim 1 wherein an element is disposed on or within a coupler IP&P or micro-platform.

3. The apparatus of claim 1 wherein one or more micro-platforms are comprised of heating and/or cooling devices.

4. The apparatus of claim 1 wherein the photonic signal is guided through a conventional photonic waveguide PW or a photonic crystal waveguide PCW and wherein the waveguide comprised of a slab, holey or slotted core structure.

5. The apparatus of claim 1 comprised of a photonic crystal waveguide sensor PCWS element operated with a slow wave waveguide mode providing a sensitivity to an analyte disposed on or near the PCWS element.

6. The apparatus of claim 1 with a photonic crystal waveguide sensor PCWS adapted to monitor and/or identifying an analyte such as a gas, vapor, particulate, liquid, solid or biomolecular mass.

7. The apparatus of claim 1 comprised of a photonic crystal waveguide filter PCWF element having its transmission controlled by a thermoelectric device or physical dimensioning.

8. The apparatus of claim 1 wherein a tetherbeam is comprised of phononic scattering or phononic resonant structure adaptations, such as, without limitation, holes, cavities, atomic-level superlattices, atomic-level vacancies and engineered surfaces providing a reduced thermal conductivity.

9. The apparatus of claim 1 wherein a detector PCWD element is comprised of a thermally-dissipative termination structure such as, without limitation, a Bragg-absorbing photonic crystal waveguide PCW, coupled resonant RLC loops, photonic crystal resonators, and a field of nanotubes.

10. The apparatus of claim 1 wherein a detector PCWD element is comprised of one or more of a Seebeck thermocouple, bolometer, or thermistor having a sensitivity to temperature changes.

11. The apparatus of claim 1 where a PCWD element is comprised of a semiconductor bandgap diode providing a direct photon to electron conversion.

12. The apparatus of claim 1 wherein the photonic source PS element is comprised of one or more of a semiconductor laser, LED, OLED, fiber optic, heated membrane or filtered blackbody plasmonic emitter.

13. The apparatus of claim 1 wherein one or more elements are formed from the device layer of a silicon-on-insulator SOI wafer.

14. The apparatus of claim 1 wherein one or more active layer or layers are comprised, without limitation, of silicon, germanium, gallium arsenide, indium arsenide, gallium nitride and alloys thereof.

15. The apparatus of claim 1 wherein cladding external to the primary of the signal waveguide comprised of, without limitation, one or more of air, silicon dioxide, silicon nitride, aluminum oxide, PDMS, and PMMA.

16. The apparatus of claim 1 wherein the temperature of a micro-platform is controlled by an electrical heater providing a means of surface outgassing.

17. The apparatus of claim 1 wherein the temperature of an element is controlled to modulate photonic signal transmisson thereby providing a means for synchronous detection and/or switching.

18. The apparatus of claim 1 with an element structured to provide a means of amplitude modulating, selective wavelength filtering or controlling the delay of a photonic signal including such structures as a Mach-Zehnder interferometer.

19. The apparatus of claim 1 wherein a photonic source PS element is comprised of an off-chip photonic emitter and having a photonic beam transmitted through, backscattered from or reflected from an analyte such as a gas, vapor, particulate, biomolecular mass or surface.

20. The apparatus of claim 1 providing a photonic wattmeter monitoring the signal power from a photonic source PS element.
